(19) United States
(12) Patent Application Publication
(10) Pub. No.: US 2011/0305496 A1
(43) Pub. Date: Dec. 15, 2011

(54) Penz mate

(76) Inventor: Hossein Jolani, Belleville, IL (US)

(21) Appl. No.: 12/799,359

(22) Filed: Jun. 15, 2010

(51) Int. Cl. B43K 23/00

(52) U.S. Cl. 401/6

(57) ABSTRACT

The Penz Mate is an external extension tool made to accompany writing utensils like pencils, pens, and markers, etc. giving the user an added holding advantage to the writing tool. The Penz Mate provides the user's finger easier access to grab the writing implement and also enables the Penz Mate user to switch stimulatingly and more efficiently and effectively between a variety of tasks to writing function and vise versa, with the least amount of time lost. The Penz Mate minimizes the misplacement of loss of writing utensils, as long as it is in use, while at the same time, is attached to the user's desired finger.

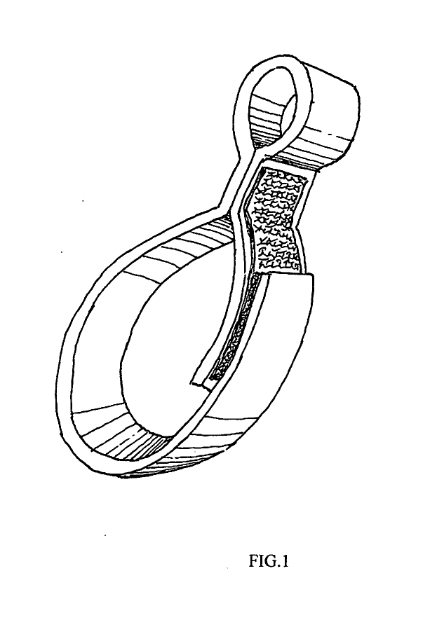

FIG. 1—It shows the general appearance of The Penz Mate, shown larger to show detail. Not actual size, view thereof; I suggest FIG. 1 for inclusion on the front page of the patent application publication and patent.

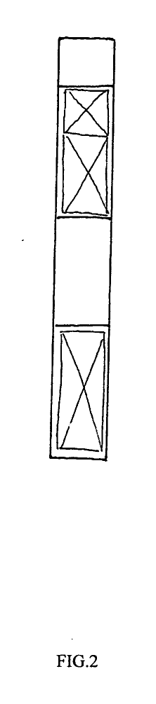

FIG. 2—This shows the back side of The Penz Mate, closure side for finger. The Top to bottom view are flat in surface, and the Velcro areas are represented by X's for closure view thereof;

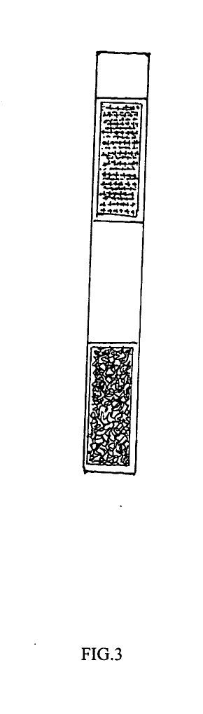

FIG. 3—This shows front view of closure side, flat view of opposite side of Velcro closure for finger view thereof;

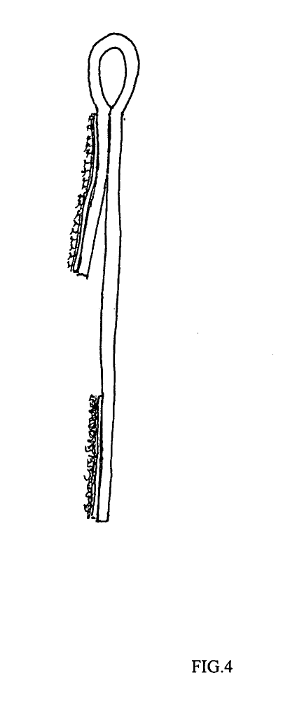

FIG. 4—The left side view open finger area/loop on top is where the writing utensil is held in place. Also right side is a mirror image of the left side view thereof;

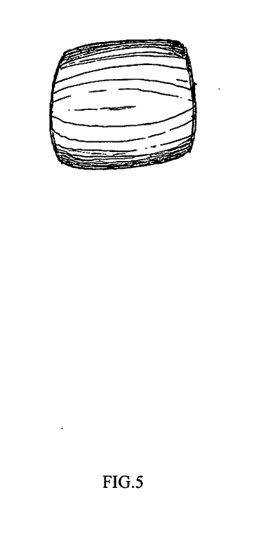

FIG. 5—Top view of area for where writing utensil is held in place, view thereof;

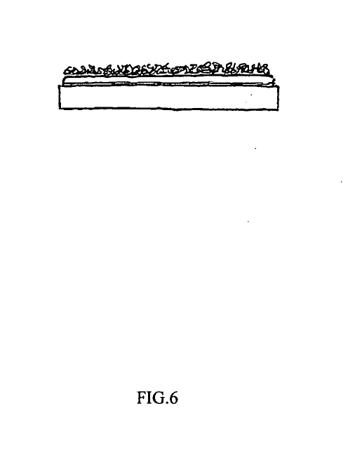

FIG. 6—This view shows the bottom/underneath of Velcro side-up, view thereof;

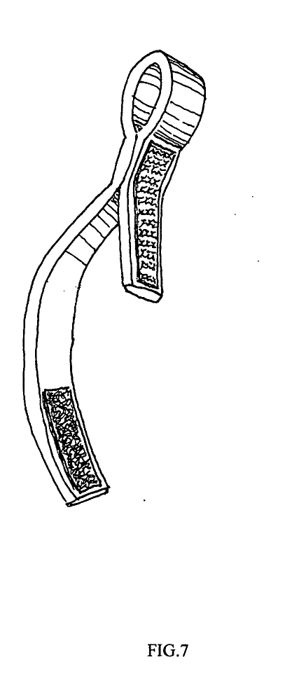

FIG. 7—This view is of a right slanted angle un-opened showing the Velcro attachments, view thereof;

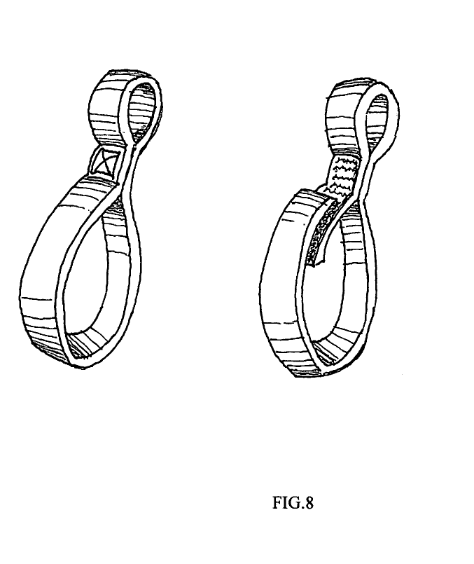

FIG. 8—Multi embodiment views in the closed position, view thereof;

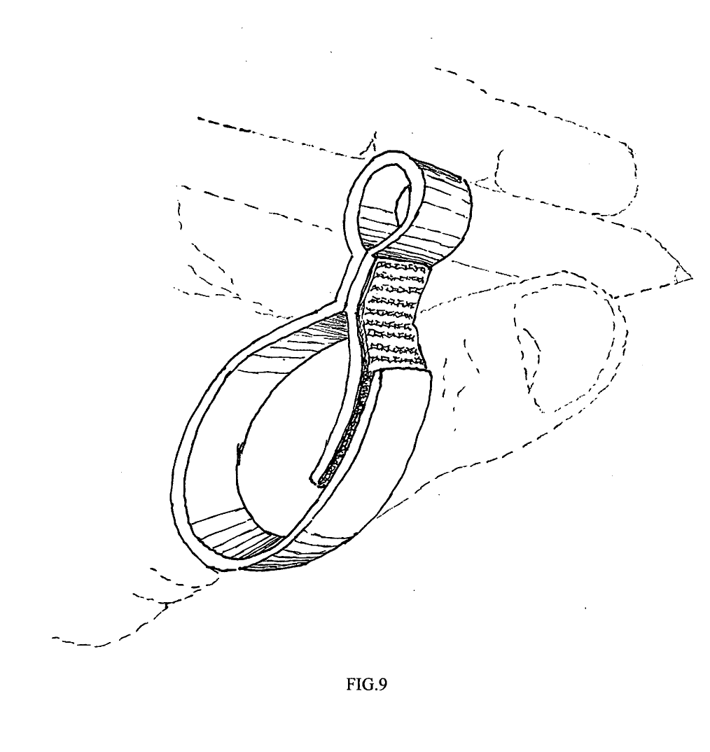

FIG. 9—This shows the front view of the Penz Mate in use, the environment for intended use is represented by the broken lines which are not part of the original design, in the closed position strapped around the writer's thumb holding the writing tool inside the Penz Mate while using writer's 2^{nd} finger as well for support, view thereof;

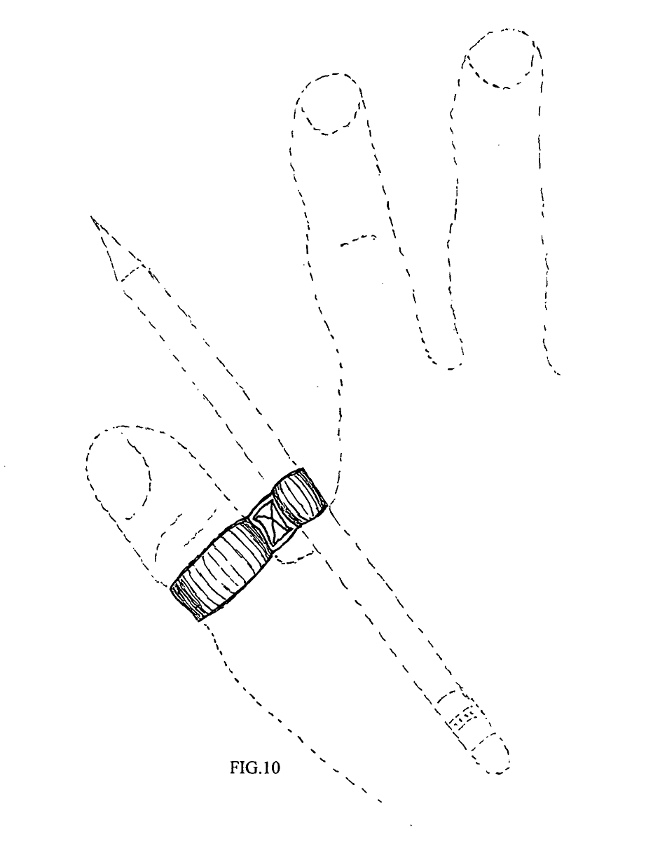

FIG. 10—This is an aerial view of the top of the Penz Mate, broken lines are the writer's thumb and 2^{nd} finger shown in environment intended for its use, and also broken lines are not part of design, view thereof;

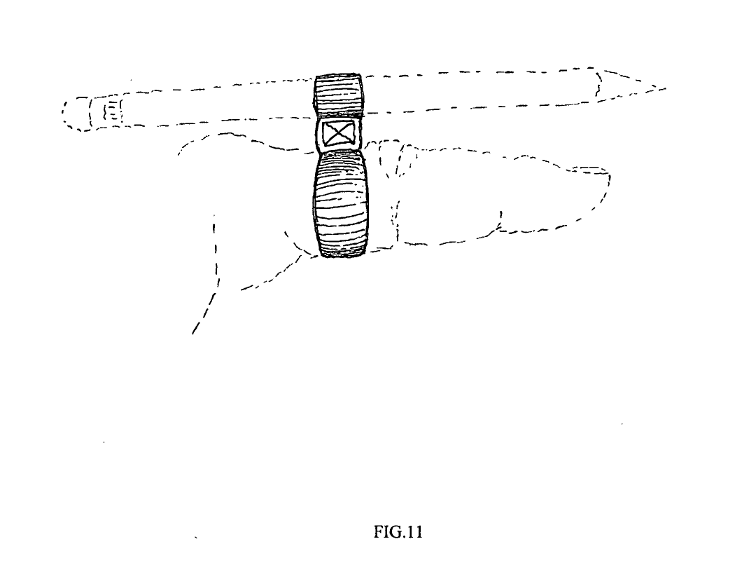

FIG. 11—This is the side view of the Penz Mate with the writing tool parallel to the writer's fingers, represented by the broken lines which are not part of the original design. The middle connection shows the separation between the finger and pen holding areas, view thereof;

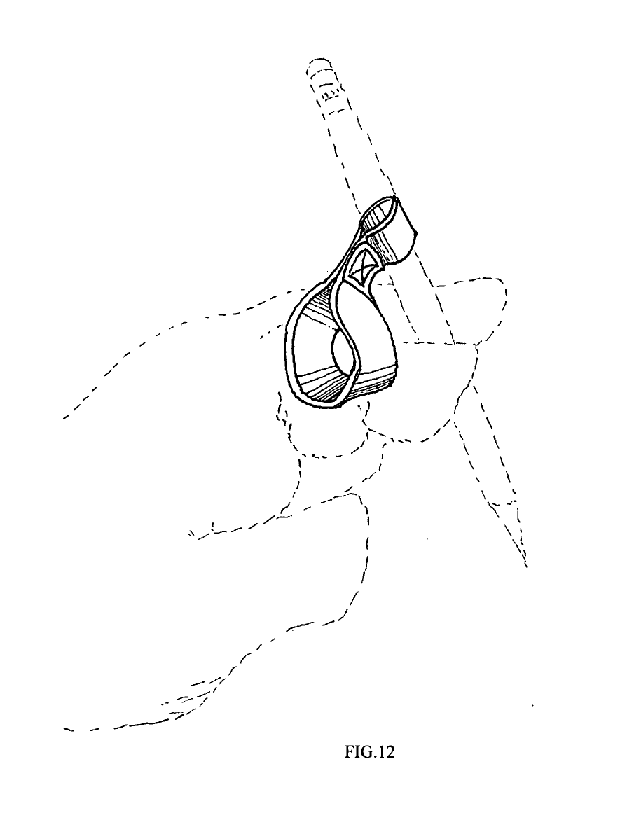

FIG. 12—This view is shown from the side and the broken lines represent the writer's fingers and hand, as an amputee using the Penz Mate, broken lines are not part of the original design, while showing the side view in use with minimal finger length as an aid to the handicapped writer. Here the 2^{nd} and middle finger of the writer are being used (Penz Mate is attached to the middle finger), view thereof;

The starting materials that are required are: 2½ inch strips of connectable Velcro, also a 4 to 6 inch length strip of elastic this is ⅜ to ½ inch in width depending on desired size.

With the following instructions followed you'll be able to assemble the Penz Mate.
A. Lay the 4 to 6 inch elastic strip down on a flat surface.
B. While the 4 to 6 inch elastic strip is flat, place a writing utensil ¼ inch down from the top of the strip of elastic to form a lower case “t” in shape.
C. From where you've measured 1½ inches inward, over lap the 1½ inch flap over the writing utensil parallel to the outer edges of the elastic strip. See FIG. 4—over lap material.
D. Un-attach the Velcro strips and lay the “brush” side up to where the over lapped area is on the elastic strip and sew, attaching the Velcro and flap to the elastic strip with an “X” ⅓ to ½ inch in diameter forming the neck, being sure to leave at least ½ inch. See FIG. 2 first box “X” in the middle.
E. By sewing the 3 over laid pieces together the writing utensil may now be removed allowing a loop to have been formed for later replacement at the desired time of use. See FIG. 4 on connected area below top loop.
F. With the over laid pieces of Velcro and elastic that were not sewn down, take the two shorter strips and sew them together with the same “X” boxed formation as before. Do not sew the longest elastic strip to the two starter pieces, as they will be needed for customizing your fit while in use. See FIG. 4 below loop, extended protrusion
G. Now take the other piece of Velcro (fluffy side up) lay it down on the opposite end of the elastic strip (on the inside) so that both Velcro pieces are folded on top of each other to hold the Penz Mate closed. This will make the edges parallel to one another on three of the four sides. See FIG. 7 side view loop on top, Velcro visual.
H. Sewing the fluffy side of the Velcro in the same box “X” manner will hold it in place. See FIG. 7—top Velcro is brush side and bottom is fluffy.
I. Your Penz Mate is assembled and ready for use with you desired choice of writing utensil. You can custom fit to your desired finger of choice by opening and re-closing the Velcro strap to your desired tightness for your comfort. See FIG. 9—The Penz Mate Strapped in use.

Not only can the Penz Mate be utilized for normal thumb and finger usage, it also the possibility of usage can be utilized as a help aide for those who have disabilities, hand/arthritic handicaps/disabilities. The possibilities for usage with one's feet are also there as well, I.E. debilitating physical abnormalities from amputation of upper limbs (hands and arms). The Penz Mate can be utilized through Physical Therapy uses as a therapeutic device is help gain strength from stroke and nerve damage to help rehabilitate and teach those who suffer how to gain hand control and help with grip training. This device is utilized for left handed and right handed or left footed and right footed users all at equal opportunity.

Everyone will find this product of use regardless of age. It can be a tool trainer for small children who are learning to grasp an object while learning the fundamentals of writing and learning how to color. This products main purpose is having a writing implement always at hand while performing many different tasks without having to stop a reach for the writing implement.

Some disadvantages of not having the Penz Mate now are: Having to always stop and pick up something to write with while you're on the computer, with the Penz Mate a pen, pencil and marker are always at your fingertips because of it being attached already. As a person who may be doing 10 key entry, having to also stop in the middle of entries and stopping for a writing utensil, the Penz Mate is there and with a quick flip they are ready to hand enter anything without stopping to find something to write with. With the pencil, pen or marker resting on top of the hand out of the way of free finger usage, this is again with a quick flip the writing implement is ready to be used with little or no effort. The Flexibility of how it lets the writing utensil rest on top of the writer's hand allowing them to keep working while always having the pen, pencil and marker at a seconds reach.

The Penz Mate is like having a sixth finger with one difference, the finger attached to your writing implement pen, pencil or marker etc. The flexibility of not always having to stop what you are doing makes this a very handy tool. Note taking is much easier as well, because the Penz Mate is already attached and while not holding anything directly in your hand you have nothing to loose the Penz Mate does the holding for you. Along with the days of holding on to your pen and pencil behind your ear or in your mouth for use are in the past, the Penz Mate relieves you from these habits as well.

My personal experience with my daily home business job is, while being on the computer seventy-five to eighty percent of the time during the day. I constantly have to stop my entries to add manually to paperwork. This causes a lot of lost time with stopping and trying to find something to write with. Having the Penz Mate has helped as a tool for me not having to stop because it is always be there for me when I needed it.

Other uses for the Penz Mate . . . artists can'use this as an added tool for holding multiple brushes or pencils while being creative, by using a cylinder block of wood with a hook that hold the Penz Mate, this can be hung or placed somewhere close to wherever it is most convenient gaining easy access to the tools that he or she uses.

Using this tool for holding a pen type flashlight for reading is another use for the Penz Mate, while having the book open for reading one can hold a Penz Mate on their choice of finger with the pen light shining directly on the page for easier reading at night.

Plumbers, electricians, or mechanics can use this as an accent tool for areas of tight spaces while needing extra points of lights. Having a pen type flashlight on their hand can give them the extra ease of another finger holding the flashlight to point in the exact direction where the light is needed.

I claim:

1. The Penz Mate, an original design is meant to be used in accordance with an already existing writing implement as a writer's helping tool, while not only giving the user a convenient place for their writing tool to sit and grab, but also is extremely easy to use and gives the writer's fingers the freedom of movement to continue normal tasks as usual while never having to lay their pen or pencil down.
